(19) United States
(12) Patent Application Publication
(10) Pub. No.: US 2003/0024143 A1
(43) Pub. Date: Feb. 6, 2003

(54) Suspended ceiling advertising module

(76) Inventor: Floyd E. Mount, Waukon, IA (US)

Correspondence Address: HENDERSON & STURM LLP, 1213 MIDLAND BUILDING, 206 SIXTH AVENUE, DES MOINES, IA, 50309-4076, US

(21) Appl. No.: 09/921,335

(22) Filed: Aug. 2, 2001

(51) Int. Cl. G09F 13/00

(52) U.S. Cl. 40/553

(57) ABSTRACT

The advertising display module of the present invention, in its broadest aspect, can be utilized in combination with a suspended ceiling as a ceiling panel to provide a decorative or ornate ceiling appearance. However, the module is particularly unique in its application as an advertising display module for use with such suspended ceilings, in that it provides a simple planar surface upon which advertising indicia can be placed. The advertising display module is formed of translucent material and can be removably substituted for any one of the ceiling panels, so that they may be strategically substituted for the ceiling panels at any location within the ceiling. More particularly still, the advertising display modules can be utilized in combination with the lighting fixtures normally provided in such suspended ceilings or, alternatively, can themselves be provided with lighting means, so that a lighted advertising display module is provided.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention relates to an advertising display module for use with suspended ceilings having spaced apart grid members defining panel receiving areas and, more particularly, to such modules which are or can be provided with indicia for advertising and which can be removably substituted for any one of the ceiling panels or lighting fixture lens normally removably supported by the grid members.

2. Description of the Related Art

Suspended ceilings formed of spaced apart grid members which removably support ceiling paenls and lighting fixtures disposed in cooperative working relationship with predetermined ones of the ceiling panels presently are well known and used extensively, particularly in supermarkets, retail stores and the like. The material from which the ceiling panels are fabricated and the grid members have, been utilized to support various types of advertising material which are affixed to the ceiling panels and the grid members. The advertising material normally is suspended by means of string or wire, or supported to hang some distance below the ceiling, by means of, for example, string, wire or the like. While such methods of displaying adverstising are widely used and accepted, it often detracts from the decor of the store and, in extreme cases, presents a rather cluttered appearance.

As can be seen by refernce to the following U.S. Pat. Nos. 4,947,570; 5,355,604; 5,282,331 and 4,856,216; the prior art is replete with myriad and diverse advertising devices used in combination with suspended ceilings.

While all of the aforementioned prior art constructions are more than adequate for the basic purpose and function for which they have been specifically designed, they are uniformly deficient with respect to their failure to provide a simple, efficient, and practical suspended ceiling advertising module.

### BRIEF SUMMARY OF THE INVENTION

Briefly stated, the advertising display module of the present invention, in its broadest aspect, can be utilized in combination with a suspended ceiling as a ceiling panel to provide a decorative or ornate ceiling appearance. However, the module is particularly unique in its application as an advertising display module for use with such suspended ceilings, in that it provides a simple planar surface upon which advertising indicia can be placed. The advertising display module is formed of translucent material and can be removably substituted for any one of the ceiling panels, so that they may be strategically substituted for the ceiling panels at any location within the ceiling. More particularly still, the advertising display modules can be utilized in combination with the lighting fixtures normally provided in such suspended ceilings or, alternatively, can themselves be provided with lighting means, so that a lighted advertising display module is provided.

In accordance with the present invention, the advertising display module comprises a simple planar translucent panel with a surface for receiving thereon advertising indicia or the like. The modules are supported by the grid members which normally support the ceiling panels and define the respective ones of the panel receiving areas, and are co-extensive in area with the respective ones of the panel receiving areas. One or more of the modules therefore can be removably disposed in conjunction with or in substitution for any one of the ceiling panels to provide readily visible advertising, at any desired location.

Accordingly, it is an object of the present invention to provide a new and improved advertising display module for use with suspended ceilings and, in particular, an advertising display panel module for use with suspended ceilings.

### BRIEF DESCRIPTION OF THE SEVERAL VIEWS OF THE DRAWINGS

These and other attributes of the invention will become more clear upon a thorough study of the following description of the best mode for carrying out the invention, particularly when reviewed in conjunction with the drawings, wherein:

FIG. 1 is a partial perspective view showing the advertising panel of the present invention supported by the grid members of a suspended ceiling with 2′×4′ panels;

FIG. 2 is a partial perspective view similar to FIG. 1, but showing the advertising panel being flexed to be installed in the suspended ceiling below a lighting fixture;

FIG. 3 is an enlarged sectoinal view taken along line 3-3 of FIG. 1;

FIG. 4 is a partial perspective view showing the advertising panel of the present invention supported in the hinged lens panel frame of a lighting fixture;

FIG. 5 is a partial perspective view similar to FIG. 4, but showing the hinged lens panel frame in the open position;

FIG. 6 is an enlarged partial exploded perspective view illustrating the corner connection of the rails of the hinged lens panel frame;

FIG. 7 is a partial perspective view showing the advertising panel of the present invention supported by the grid members of a suspended ceiling with 2′×2′ panels;

FIG. 8 is a partial perspective view similar to FIG. 7, but showing the advertising panel being flexed to be installed and supported by the grid members; and

FIG. 9 is an enlarged sectional view taken along line 9-9 of FIG. 7.

### DETAILED DESCRIPTION OF THE INVENTION

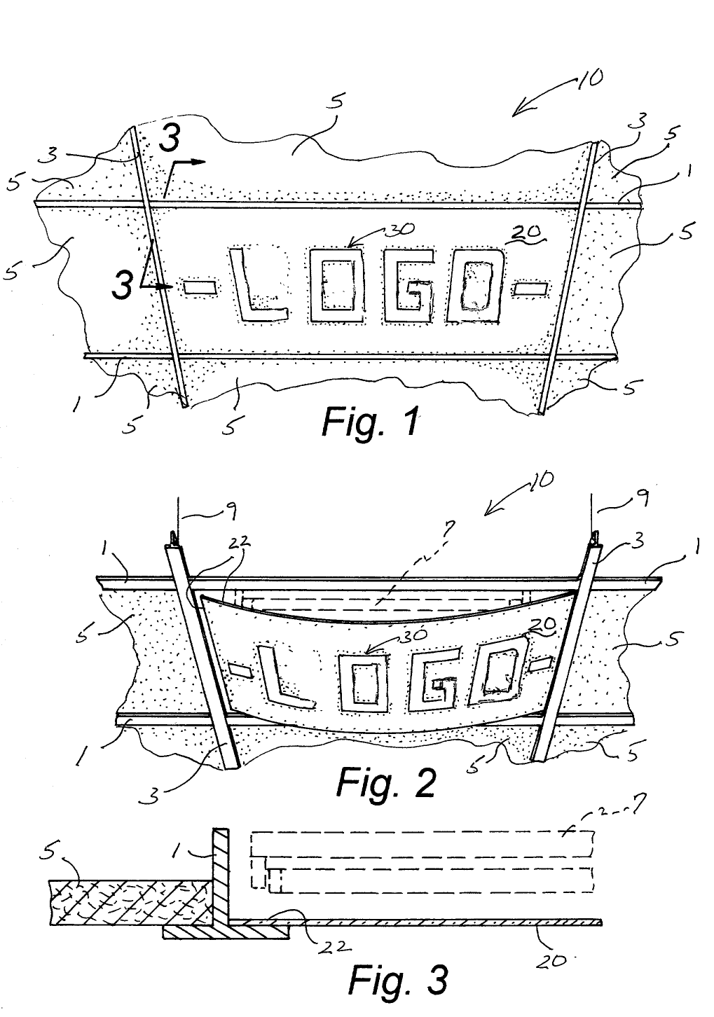

As can be seen by reference to the drawings, and in particular to FIG. 1, the suspended ceiling advertising module that forms the basis of the present invention is designated generally by the reference number 10.

In FIG. 1 there is generally represented a suspended ceiling of a typical construction including a plurality of longitudinal and transverse grid members 1 and 3 which are suspended from supporting wires 9 and are mounted in spaced apart relationship defining a plurality of panel receiving areas in which ceiling panels 5 normally are removably disposed. In many instances, at various locations, lighting fixtures 7 are installed in operative relationship with one of the panel receiving areas defined by the grid members 1 and 3. In such cases, the ceiling panel 5 is replaced with a translucent lighting panel or the like, to provide a source of light. In FIG. 1, an advertising display panel 20 is illustrated as it is removably supported at its peripheral edges 22 by the longitudinal and transverse grid members 1 and 3, in substitution for one of the ceiling panels 5.

The advertising display panel 20 may be made in various dimensions and of various suitable materials. Perferably, the panel 20 is planar and made of a translucent plastic material such as acrylic plexiglass having a thickness of about 0.080 inches and a length and width of 2′×4′ or 2′×2′, so it can be accommodated by standard suspended ceiling grids. The surface of the panel 20 receives advertising indicia 30 that may be applied by various methods, preferably by silkscreening, and the advertising indicia 30 may relate to any of a variety of goods or services.

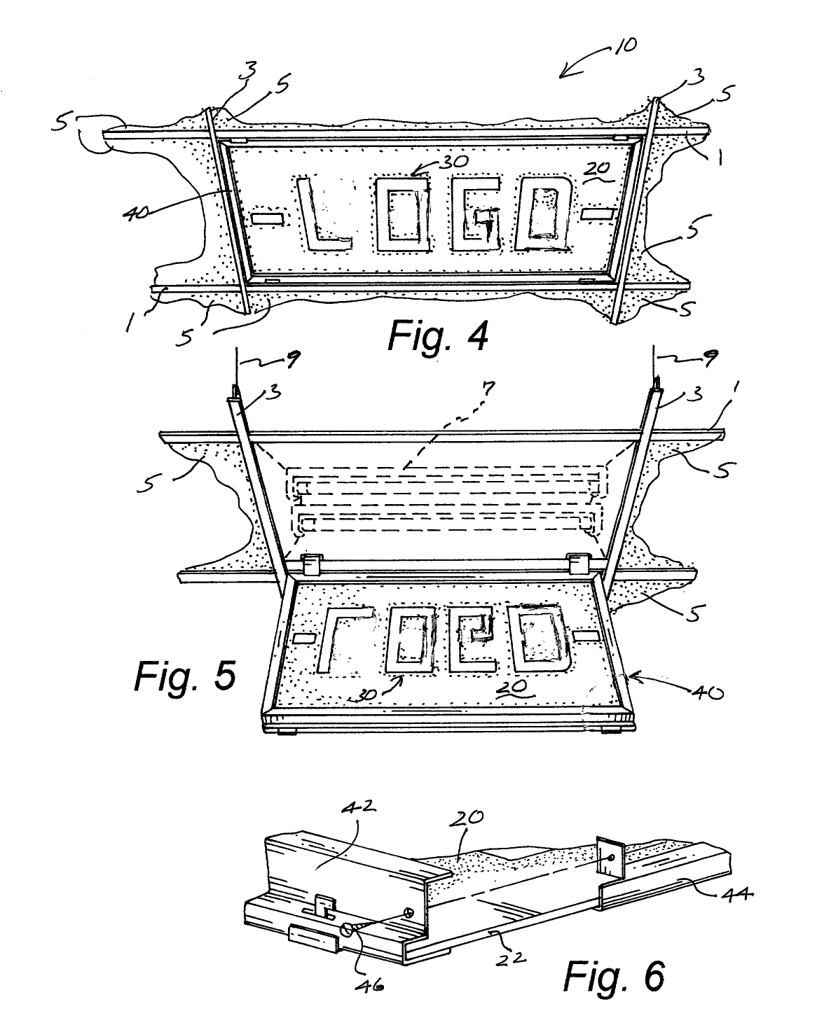

FIGS. 4-6 show the advertising display panel 20 substituted for the standard lens panel of a lighting fixture having a hinged lens panel frame 40 which is operably supported by the longitudinal and transverse grid members 1 and 3. FIG. 6 illustrates the separation of the longitudinal side rail 42 of the frame 40 from the transverse rail 44 by removal of the screw 46 so that the standard lens panel can be removed and the advertising display panel 20 can be substituted.

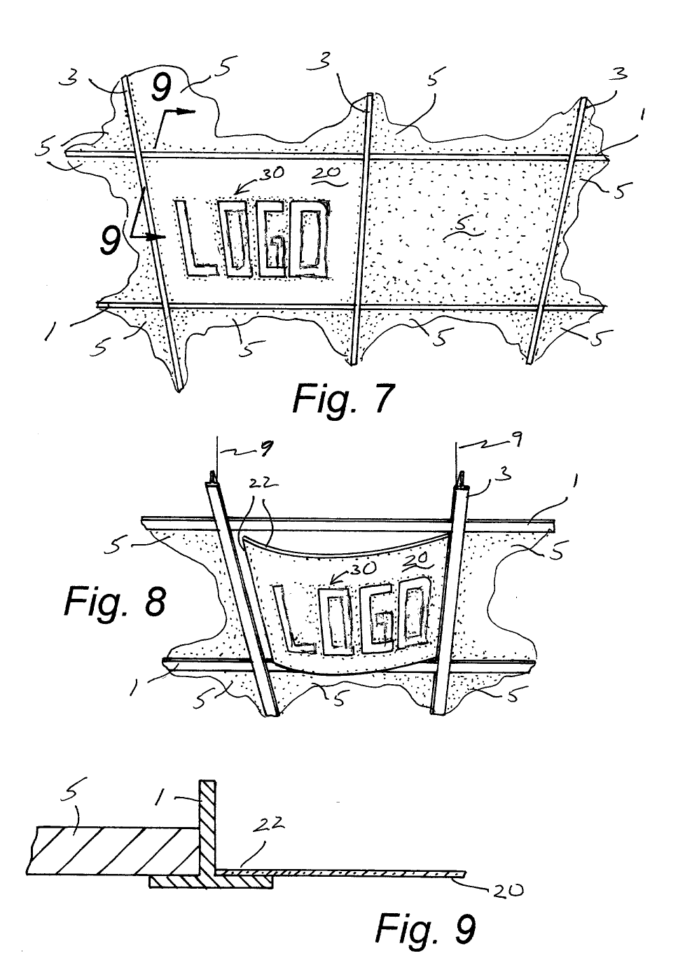

FIGS. 7-9 show an alternate embodiment of the invention where a 2′×2′ advertising display panel 20 is supported by the grid members 1 and 3 and there are no lighting fixtures disposed above the suspended ceiling.

Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

I claim:

1. An advertising display module for use with suspended ceilings having spaced-apart grid members defining panel receiving areas, ceiling panels removably supported by said grid members in said panel receiving areas and lighting fixtures disposed above and in cooperative working relationship with pre-determined ones of said ceiling panels, said advertising display module, comprising:
a planar translucent advertising panel having a surface, advertising indicia received on the surface, and a peripheral edge disposed to contract and be supported by the grid members within a selected one of said panel receiving areas;
said advertising panel being co-extensive in area with the respective ones of said panel receiving areas and supported by said grid members defining the respective ones of said panel receiving areas, whereby one or more of said advertising panels can be removably disposed in conjunction with or in substitution for any one of said ceiling panels to provide readily visible advertising.

2. The advertising display module of claim 1 wherein the advertising panel is formed of plastic.

3. The advertising display module of claim 2 wherein the plastic is acrylic plexiglass.

4. The advertising display module of claim 1 wherein the advertising panel is about 0.080 inches thick.

5. The advertising display module of claim 4 wherein the advertising panel has a width of about two feet and a length of about four feet.

6. The advertising display module of claim 4 wherein the advertising panel has a width of about two feet and a length of about two feet.

7. The advertising display module of claim 1 wherein the indicia is applied to the surface by silkscreening.

8. An advertising display module for use with suspended ceilings having spaced-apart grid members defining panel receiving areas, ceiling panels removably supported by said grid members in said panel receiving areas and lighting fixtures including hinged lens panel frames disposed above and in cooperative working relationship with pre-determined ones of said panel receiving areas, said advertising display module, comprising:
a planar translucent advertising panel having a surface, advertising indicia received on the surface, and a peripheral edge disposed to contract and be supported by a selected one of the lens panel frames;
said advertising panel being co-extensive in area with the respective ones of said lens panel frames and supported thereby, whereby one or more of said advertising panels can be removably disposed in conjunction with or in substitution for any one of said lens panel frames to provide readily visible advertising.

9. The advertising display module of claim 8 wherein the advertising panel is formed of plastic.

10. The advertising display module of claim 9 wherein the plastic is acrylic plexiglass.

11. The advertising display module of claim 8 wherein the advertising panel is about 0.080 inches thick.

12. The advertising display module of claim 11 wherein the advertising panel has a width of about two feet and a length of about four feet.

13. The advertising display module of claim 11 wherein the advertising panel has a width of about two feet and a length of about two feet.

14. The advertising display module of claim 8 wherein the indicia is applied to the surface by silkscreening.

15. An advertising display module for use with suspended ceilings having spaced-apart grid members defining panel receiving areas, and ceiling panels removably supported by said grid members in said panel receiving areas, said advertising display module, comprising:
a planar translucent advertising panel having a surface, advertising indicia received on the surface, and a peripheral edge disposed to contract and be supported by the grid members within a selected one of said panel receiving areas;
said advertising panel being co-extensive in area with the respective ones of said panel receiving areas and supported by said grid members defining the respective ones of said panel receiving areas, whereby one or more of said advertising panels can be removably disposed in conjunction with or in substitution for any one of said ceiling panels to provide readily visible advertising.

16. The advertising display module of claim 15 wherein the advertising panel is formed of plastic.

17. The advertising display module of claim 16 wherein the plastic is acrylic plexiglass.

18. The advertising display module of claim 15 wherein the advertising panel is about 0.080 inches thick.

19. The advertising display module of claim 18 wherein the advertising panel has a width of about two feet and a length of about four feet.

20. The advertising display module of claim 18 wherein the advertising panel has a width of about two feet and a length of about two feet.

21. The advertising display module of claim 15 wherein the indicia is applied to the surface by silkscreening.
